(19) United States
(12) Patent Application Publication
(10) Pub. No.: US 2024/0177061 A1
(43) Pub. Date: May 30, 2024

(54) LABEL ACCURACY IMPROVEMENT DEVICE, LABEL ACCURACY IMPROVEMENT METHOD, AND STORAGE MEDIUM

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Fumihiko HYUGA, Kawasaki Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/457,546

(22) Filed: Aug. 29, 2023

(30) Foreign Application Priority Data
Nov. 29, 2022 (JP) 2022-190077

(51) Int. Cl. G06N 20/00; G06N 5/04

(52) U.S. Cl. CPC G06N 20/00; G06N 5/04

(57) ABSTRACT

A label accuracy improvement device includes a controller. The controller executes unit processing. The unit processing includes learning processing, determination processing and label update processing. The learning processing uses labeled data, estimates a label based on non-label data, which is data to which a label is assigned in learning data, and updates a mathematical model for obtaining a likelihood. The determination processing determines whether conditions related to a difference between a label estimated by a mathematical model learned based on the non-label data and a label included in the learning data and an inference score that is greater as a magnitude of a likelihood is greater are satisfied. The label update processing updates a label when the conditions are satisfied.

### CROSS-REFERENCE TO RELATED APPLICATION

This application is based upon and claims the benefit of priority from Japanese Patent Application No. 2022-190077, filed Nov. 29, 2022; the entire contents of which are incorporated herein by reference.

### FIELD

An embodiment of the present invention relates to a label accuracy improvement device, a label accuracy improvement method, and a storage medium.

### BACKGROUND

In recent years, a technology of machine learning has been developed. In machine learning, learning of a mathematical model using data to which a label, which is a value that indicates a correct answer, is assigned may be performed. In such cases, labels are often assigned by people. However, since the amount of data used for learning is large, people sometimes make mistakes when assigning labels. Specifically, there have been cases where an assigned label did not actually indicate a correct answer.

### BRIEF DESCRIPTION OF THE DRAWINGS

FIG. 1 is an explanatory diagram which describes an outline of a label accuracy improvement device of an embodiment.

FIG. 2 is an explanatory diagram which describes an example of a result of estimating a label estimation model in the embodiment.

FIG. 3 is a diagram which shows an example of a hardware configuration of the label accuracy improvement device in the embodiment.

FIG. 4 is a flowchart which shows an example of a flow of processing executed by the label accuracy improvement device in the embodiment.

### DETAILED DESCRIPTION

Hereinafter, a label accuracy improvement device, a label accuracy improvement method, and a program of the embodiment will be described with reference to the drawings.

A label accuracy improvement device includes a controller. The controller executes unit processing. The unit processing includes learning processing, determination processing and label update processing. The learning processing includes performing learning that uses labeled data as learning data, sets a mathematical model for estimating a label to be assigned to non-label data which is data to which a label is to be assigned in the learning data based on the non-label data to obtain a result of the estimation and a likelihood of the result of the estimation as a learning target, and updates the mathematical model to reduce a first label error, which is a difference between an estimated label of the learning target and a label included in the learning data. The determination processing includes determining whether determination conditions that are predetermined conditions related to a second label error, which is a difference between a result estimated by the learned mathematical model based on the non-label data in the learning data and a label included in the learning data, and an inference score, which is a value that is greater as a magnitude of a likelihood obtained by the mathematical model is greater, are satisfied. The label update processing includes updating a label included in the learning data according to a predetermined rule based on the non-label data when it is determined in the determination processing that the determination conditions are satisfied. The determination conditions are conditions including a condition that both a condition that the second label error is greater than a predetermined magnitude and a condition that the inference score is greater than a predetermined magnitude are satisfied.

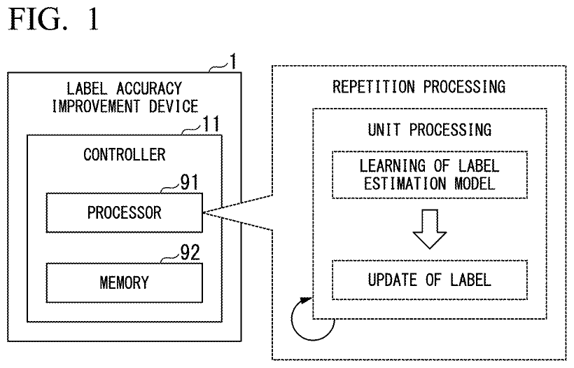

FIG. 1 is an explanatory diagram which describes an outline of a label accuracy improvement device 1 of the embodiment. The label accuracy improvement device 1 includes a controller 11 having a processor 91 such as a central processing unit (CPU) and a memory 92 connected via a bus, and executes a program.

The controller 11 executes repetition processing. The repetition processing is processing of executing unit processing until a predetermined end condition (hereinafter referred to as a “repetition end condition”) related to the repetition processing is satisfied. The unit processing includes learning processing and data update processing.

Learning processing is processing of executing learning to update a mathematical model to be learned using learning data. There are one or a plurality of pieces of learning data used in the learning processing. Learning data is specifically labeled data.

A target of learning in the learning processing is a label estimation model. The label estimation model is a mathematical model that estimates a label to be assigned to non-label data based on data to which a label is to be assigned (hereinafter referred to as “non-label data”) in the learning data, and obtains a result of the estimation and a likelihood (certainty) of the result of the estimation. In the learning processing, the label estimation model is then updated to reduce a difference between the label estimated by the label estimation model and the label included in the learning data (hereinafter referred to as a “first label error.”)

The likelihood may be defined to indicate a probability that the estimated label is a true value, or may be defined to indicate a probability that the estimated label is not a true value. In addition, the likelihood may also be defined to indicate the probability that the estimated label is a true value and the probability that the estimated label is not a true value.

Learning in each unit processing is executed until a predetermined condition related to an end of the learning processing (hereinafter referred to as a “learning end condition”) is satisfied. The learning end condition may be, for example, a condition that a change in the label estimation model due to updating is smaller than a predetermined change. The learning end condition may be, for example, a condition that updating has been performed a predetermined number of times.

In the field of machine learning, the word “learned” is used. In one use of this word, the label estimation model at a time when the learning end condition is satisfied could be called a learned label estimation model. However, learning is completed only in unit processing when the learning end condition is determined. Therefore, the learned label estimation model can be further updated in the next unit processing.

The data update processing includes determination processing and label update processing. The determination processing is processing for determining whether determination conditions, which are predetermined conditions related to a second label error and an inference score, are satisfied. The second label error is the difference between the label estimated by the learned label estimation model based on the non-label data in the learning data and the label included in the learning data.

The inference score is a value that is greater as a magnitude of the likelihood obtained by the label estimation model is greater. For example, when a domain of likelihood is defined as −100 to +100, an absolute value of a positive value indicates a probability that a result of the estimation is correct, and when an absolute value of a negative value indicates that a result of the estimation is erroneous, the estimated score may be, for example, the absolute value of the likelihood. For example, when a domain of the likelihood is defined to be 0 to 100, the estimated score may be, for example, the likelihood itself.

Specifically, the determination conditions may further include a condition that includes a condition that both a condition that the second label error is greater than a predetermined magnitude and a condition that the inference score is greater than a predetermined magnitude are satisfied.

For example, when there are a plurality of pieces of learning data used in the learning processing, the determination conditions may further include a condition that the magnitude of the second label error obtained for each piece of learning data is within an Nth (N is a predetermined positive integer) position from the largest magnitude.

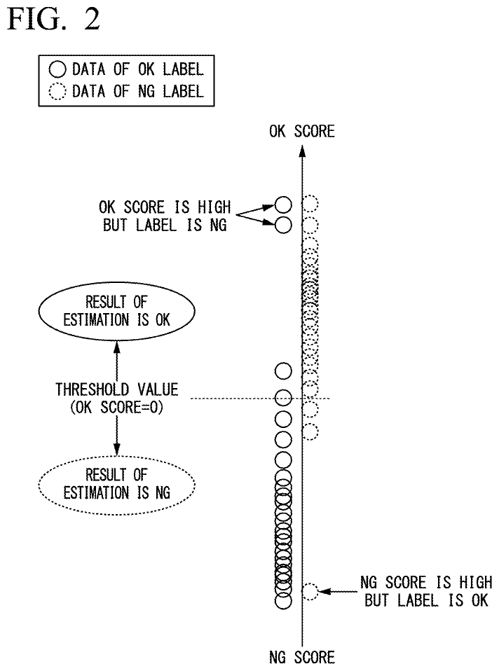

FIG. 2 is an explanatory diagram which describes an example of a type of a label estimated by the label estimation model in the embodiment. In the example of FIG. 2, there is a case in which a threshold value for a likelihood is determined in advance, and the threshold value is expressed as OK score=0. In FIG. 2, an OK score indicates an absolute value of a difference between an estimated score and the threshold value when the estimated score is greater than the threshold value. In FIG. 2, an NG score indicates an absolute value of the difference between an estimated score and the threshold value when the estimated score is equal to or less than the threshold value. In FIG. 2, OK label and NG label indicate two types of labels used for learning.

Note that the description of FIG. 2 is a description using two-class classification as an example. OK label is, for example, a label of a class 1, and NG label is a label of a class 2. In learning, one of these labels is assigned to each piece of data, and they are used as labeled data. Classes in the case of three-class classification are, for example, three classes such as a class 1 label, a class 2 label, and a class 3 label. In this manner, OK label and NG label are words specialized for two-class classification, and are words used for the sake of simplicity of description.

In FIG. 2, “OK score is high but a label is NG” means that the second label error is greater than a predetermined magnitude even though the estimated score is greater than the threshold value. In FIG. 2, “NG score is high but a label is OK” means that the second label error is smaller than a predetermined magnitude even though the estimated score is equal to or less than the threshold value.

Returning to the description of FIG. 1, the label update processing is processing for updating the label included in the learning data according to a label update rule based on the non-label data when it is determined that the determination conditions are satisfied by the determination processing.

The label update rule is a predetermined rule for an update of a label. The label update rule is, for example, a rule to update the label included in the learning data to a classification result label. The classification result label is a label indicating a result of classifying the non-label data included in the learning data by a pre-learned classifier that classifies a classification target with a predetermined accuracy or higher.

In addition, when there are a plurality of pieces of learning data used in the learning processing, learning data that satisfies the determination conditions is not necessarily all of the learning data used in the learning processing. In such a case, label update processing may be performed only for the learning data that satisfies the determination conditions, or may be executed for all of the learning data regardless of whether the determination conditions are satisfied.

In this manner, unit processing includes processing to update the mathematical model to be learned and processing of updating the label included in the learning data used for learning. For this reason, the unit processing is executed, and thereby the mathematical model to be learned and the label included in the learning data are updated.

As described above, the repetition processing is processing of repeating the unit processing until the repetition end condition is satisfied. However, more specifically, in second and subsequent unit processing in the repetition processing, instead of the learning data and mathematical model used in the previous unit processing, learning data and a mathematical model updated in the previous unit processing are used.

That is, in the next unit processing after i^{th} unit processing is executed, instead of the learning data and the mathematical model from before the update of the i^{th} unit processing, learning data and a mathematical model from after the update of the i^{th} unit processing are used. Note that i is an integer of 1 or more.

Note that the repetition end condition is, for example, a condition that unit processing has been updated a predetermined number of times. The repetition end condition may be, for example, a condition that the second label error is smaller than a predetermined difference for all of the learning data used in the learning processing.

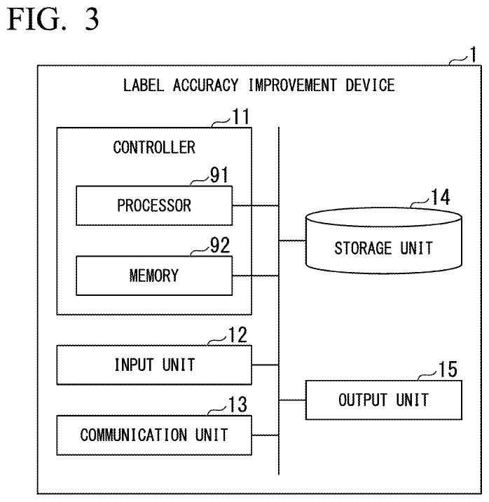

FIG. 3 is a diagram which shows an example of a hardware configuration of the label accuracy improvement device 1 in the embodiment. As described above, the label accuracy improvement device 1 includes a controller 11 having a processor 91 such as a CPU and a memory 92 connected via a bus, and executes a program. The label accuracy improvement device 1 functions as a device including the controller 11, an input unit 12, a communication unit 13, a storage unit 14, and an output unit 15 by executing the program.

More specifically, the processor 91 reads the program stored in the storage unit 14 and stores the read program in the memory 92. The processor 91 executes the program stored in the memory 92, and thereby the label accuracy improvement device 1 functions as a device including a controller 11, an input unit 12, a communication unit 13, a storage unit 14, and an output unit 15.

The controller 11 controls operations of various functional units provided in the label accuracy improvement device 1. The controller 11 executes, for example, the repetition processing.

The input unit 12 includes input devices such as a mouse, a keyboard, and a touch panel. The input unit 12 may be configured as an interface connecting these input devices to the label accuracy improvement device 1. The input unit 12 receives an input of various types of information for the label accuracy improvement device 1. For example, a user's instruction to start the repetition processing is input to the input unit 12. Learning data is input to, for example, the input unit 12.

The communication unit 13 is configured to include a communication interface for connecting the label accuracy improvement device 1 to an external device. The communication unit 13 communicates with an external device with wire or wirelessly. An external device is, for example, a device from which learning data is transmitted. The communication unit 13 acquires learning data through communication with the device from which the learning data is transmitted.

The storage unit 14 is configured using a computer-readable storage medium device (a non-transitory computer-readable recording medium) such as a magnetic hard disk device or a semiconductor storage device. The storage unit 14 stores various types of information regarding the label accuracy improvement device 1. The storage unit 14 stores information input via, for example, the input unit 12 or the communication unit 13. The storage unit 14 stores various types of information generated by, for example, the repetition processing.

The output unit 15 outputs various types of information. The output unit 15 is configured to include a display device such as a cathode ray tube (CRT) display, a liquid crystal display, or an organic electro-luminescence (EL) display. The output unit 15 may be configured as an interface for connecting these display devices to the label accuracy improvement device 1. The output unit 15 outputs, for example, information input to the input unit 12 or the communication unit 13.

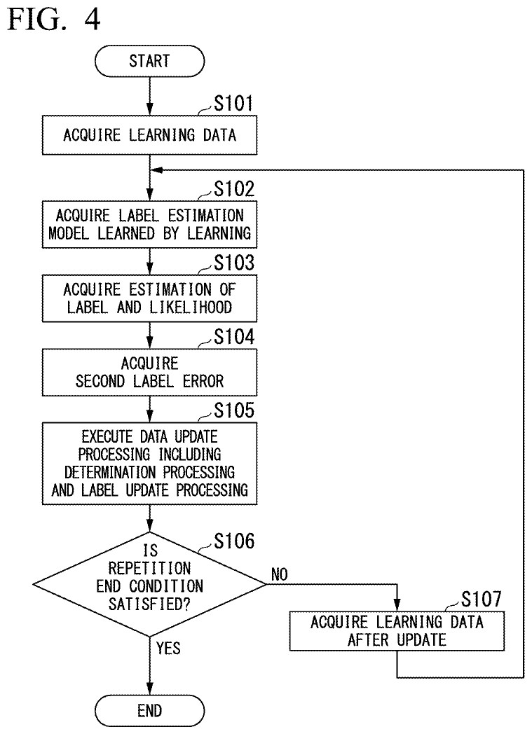

FIG. 4 is a flowchart which shows an example of a flow of processing executed by the label accuracy improvement device 1 in the embodiment. A case where the number of pieces of learning data used in learning processing is M (M is an integer equal to or greater than 1) will be described below as an example.

The controller 11 acquires M pieces of learning data used in learning processing (step S101). Next, the controller 11 performs learning using each piece of learning data acquired as learning data used in the learning processing to obtain a learned label estimation model (step S102). That is, the controller 11 performs the learning processing and obtains a label estimation model.

Next, the controller 11 executes the learned label estimation model for non-label data in the learning data for each piece of the learning data (step S103). By executing step S103, the learned label estimation model estimates a label assigned to non-label data in the learning data for each piece of the learning data, and acquires a likelihood of a result of the estimation.

Next, the controller 11 obtains, for each piece of the learning data, a difference between the label estimated by the learned label estimation model in step S103 and the label included in the learning data in step S103 (step S104). The learning data in step S103 is learning data including non-label data on which the learned label estimation model is executed in step S103. The difference obtained in step S104 is the second label error.

Next, the controller 11 performs data update processing (step S105). As described above, data update processing includes determination processing and label update processing. More specifically, determination processing using the second label error obtained in step S104 and the likelihood obtained in step S103 is executed in data update processing. That is, the controller 11 uses the second label error obtained in step S104 and the likelihood obtained in step S103 to determine whether the determination conditions are satisfied for each piece of the learning data.

Then, in the data update processing, when the determination conditions are satisfied, label update processing is executed. On the other hand, when the determination conditions are not satisfied, the controller 11 performs an operation according to a predetermined rule in the data update processing. When the predetermined rule is a rule in which the label update processing is performed regardless of whether the determination conditions are satisfied, the controller 11 performs the label update processing. When the predetermined rule is a rule in which the label update processing is not performed when the determination conditions are not satisfied, the controller 11 will not perform the label update processing.

The processing from step S102 to step S105 is an example of unit processing.

After the data update processing, the controller 11 determines whether the repetition end condition is satisfied (step S106). When the repetition end condition is satisfied (YES in step S106), the processing will end.

On the other hand, when the repetition end condition is not satisfied (NO in step S106), the controller 11 further executes unit processing using the learning data and mathematical model updated by the unit processing of steps S102 to S105. That is, when the repetition end condition is not satisfied, the controller 11 acquires each piece of the learning data after the data update processing as learning data to be used in the next learning processing (step S107). Next, the processing returns to step S102.

The label accuracy improvement device 1 of the embodiment configured in this manner includes the controller 11 that performs the learning processing and the data update processing. That is, the label accuracy improvement device 1 updates the label estimation model for estimating a label by the learning processing, and updates the learning data used for learning of the label estimation model according to an update of the label by the data update processing. Then, the label accuracy improvement device 1 further learns the label estimation model using learning data containing labels with even more correct content. As a result, of course, an accuracy in estimation of the label estimation model is improved.

Then, using a result of the estimation of the label estimation model with improved accuracy, the label accuracy improvement device 1 further updates the label. In this manner, if the label accuracy improvement device 1 is used, an initial label in labeled data is updated to a label with higher accuracy. For this reason, the label accuracy improvement device 1 can improve the probability that a label indicates a correct answer.

### Modified Example

Each piece of the learning data acquired by the controller 11 in step S101 is data to which a label estimated using a predetermined classifier is assigned for each piece of data in a set of non-label data. In such a case, since the learning data is prepared using the classifier, a burden on a person required to prepare the learning data is reduced compared to when the classifier is not used. Each piece of the learning data acquired by the controller 11 in step S101 is an example of the learning data used in learning in the first unit processing.

Each piece of the learning data acquired by the controller 11 in step S101 is data to which affiliation information is assigned as a label for each piece of data in a classification target set, which is a set of data to which no label is assigned. The affiliation information is information indicating to which classification each piece of data belongs, which is obtained as a result of predetermined clustering for the classification target set.

Since clustering is a technology executed by a device, in such cases, learning data is prepared using a classifier. Therefore, the burden on the person required to prepare the learning data is reduced compared to when a classifier is not used. Each piece of the learning data acquired by the controller 11 in step S101 is an example of the learning data used in learning in the first unit processing. The predetermined clustering method may be, for example, a k-means method or a MeanShift method.

In each of the embodiments described above, it is assumed that the controller 11 is a software functional unit, but it may be a hardware functional unit such as LSI.

According to at least one of the embodiments described above, by having a controller that performs learning processing and data update processing, it is possible to improve the probability that a label indicates a correct answer.

The label accuracy improvement device 1 may be mounted using a plurality of information processing devices communicably connected via a network. In this case, the controller 11 may be distributed and mounted in the plurality of information processing devices.

All or some of functional units of the label accuracy improvement device 1 may be realized using hardware such as an application specific integrated circuit (ASIC), a programmable logic device (PLD), and a field programmable gate array (FPGA). A program may be recorded on a computer-readable recording medium. A computer-readable recording medium is, for example, a portable medium such as a flexible disk, a magneto-optical disc, a ROM, or a CD-ROM, or a storage device such as a hard disk incorporated in a computer system. The program may be transmitted via electric telecommunication lines.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label accuracy improvement device comprising:
a controller configured to execute unit processing including learning processing of performing learning that uses labeled data as learning data, sets a mathematical model for estimating a label to be assigned to non-label data which is data to which a label is to be assigned in the learning data based on the non-label data to obtain a result of the estimation and a likelihood of the result of the estimation as a learning target, and updates the mathematical model to reduce a first label error, which is a difference between an estimated label of the learning target and a label included in the learning data,
determination processing of determining whether determination conditions that are predetermined conditions related to a second label error, which is a difference between a result estimated by the learned mathematical model based on the non-label data in the learning data and a label included in the learning data, and an inference score, which is a value that is greater as a magnitude of a likelihood obtained by the mathematical model is greater, are satisfied, and
label update processing of updating a label included in the learning data according to a predetermined rule based on the non-label data when it is determined in the determination processing that the determination conditions are satisfied,
wherein the determination conditions are conditions including a condition that both a condition that the second label error is greater than a predetermined magnitude and a condition that the inference score is greater than a predetermined magnitude are satisfied.

2. The label accuracy improvement device according to claim 1,
wherein the predetermined rule is a rule for updating a label included in the learning data to a label indicating a result of classifying non-label data included in the learning data by a classifier that is a pre-learned classifier and classifies a classification target with a predetermined accuracy or higher.

3. The label accuracy improvement device according to claim 1,
wherein each piece of learning data used in the learning processing of first unit processing is data to which a label estimated using a predetermined classifier is assigned for each piece of data in a set of non-label data.

4. The label accuracy improvement device according to claim 1,
wherein each piece of learning data used in the learning processing of first unit processing is, for each piece of data in a set of non-label data, data to which information, indicating to which of classifications resulting from predetermined clustering of the set each piece of the data belongs, is assigned as a label.

5. The label accuracy improvement device according to claim 1,
wherein the controller further executes the unit processing of using the learning data and the mathematical model that have been updated in the unit processing instead of the learning data and the mathematical model that have not yet been updated in the unit processing after the unit processing is executed.

6. A label accuracy improvement method comprising:
a control step of executing unit processing including learning processing of performing learning that uses labeled data as learning data, sets a mathematical model for estimating a label to be assigned to non-label data which is data to which a label is to be assigned in the learning data based on the non-label data to obtain a result of the estimation and a likelihood of the result of the estimation as a learning target, and updates the mathematical model to reduce a first label error, which is a difference between an estimated label of the learning target and a label included in the learning data,
determination processing of determining whether determination conditions that are predetermined conditions related to a second label error, which is a difference between a result estimated by the learned mathematical model based on the non-label data in the learning data and a label included in the learning data, and an inference score, which is a value that is greater as a magnitude of a likelihood obtained by the mathematical model is greater, are satisfied, and
label update processing of updating a label included in the learning data according to a predetermined rule based on the non-label data when it is determined in the determination processing that the determination conditions are satisfied,
wherein the determination conditions are conditions including a condition that both a condition that the second label error is greater than a predetermined magnitude and a condition that the inference score is greater than a predetermined magnitude are satisfied.

7. A computer-readable non-transitory storage medium storing a program for causing a computer to function as the label accuracy improvement device described in claim 1.
